(19) United States
(12) Patent Application Publication
(10) Pub. No.: US 2016/0032803 A1
(43) Pub. Date: Feb. 4, 2016

(54) Exhaust After-treatment System Having Low Temperature SCR Catalyst

(71) Applicant: Tenneco Automotive Operating Company Inc., Lake Forest, IL (US)

(72) Inventors: Padmanabha Reddy Ettireddy, Canton, MI (US); Adam J. Kotrba, Laingsburg, MI (US); Thomas Spinks, Grass Lake, MI (US); Boningari Thirupathi, Grass Lake, MI (US); Panagiotis Smirniotis, Grass Lake, MI (US)

(21) Appl. No.: 14/445,686

(22) Filed: Jul. 29, 2014

(51) Int. Cl. F01N 3/20; B01J 29/70; B01J 35/00; B01J 29/78; B01J 37/03; B01J 37/02; F01N 3/035; B01J 29/76

(52) U.S. Cl. CPC F01N 3/208; F01N 3/035; B01J 29/7057; B01J 29/7615; B01J 29/7815; B01J 37/035; B01J 37/0201; B01J 35/0006; F01N 2370/04; F01N 2610/02; B01J 2229/186

(57) ABSTRACT

An aftertreatment system for treating exhaust gas discharged from a combustion engine, the aftertreatment system comprising a low temperature selective-catalytic-reduction catalyst, wherein the low-temperature selective-catalytic-reduction catalyst is a mixture of catalytic metals provided on a beta-zeolite support material, the mixture of catalytic metals being at least one mixture selected from Cu and Ce, Mn and Ce, Mn and Fe, Cu and W, Mn and W, and Ce and W.

### FIELD

The present disclosure relates to an exhaust after-treatment system having a low temperature SCR catalyst.

### BACKGROUND

This section provides background information related to the present disclosure and is not necessarily prior art.

In an attempt to reduce the quantity of NOₓ and particulate matter emitted to the atmosphere during internal combustion engine operation, a number of exhaust aftertreatment devices have been developed. A need for exhaust aftertreatment systems particularly arises when diesel combustion processes are implemented. Typical aftertreatment systems for diesel engine exhaust may include one or more of a hydrocarbon (HC) injector and a diesel oxidation catalyst (DOC), a diesel particulate filter (DPF), a selective catalytic reduction (SCR) system (including a urea or ammonia dosing system), and an ammonia oxidation catalyst (AMOX) or ammonia slip catalysts.

Following a cold start of an engine, exhaust gas temperatures are much lower than exhaust gas temperatures produced by the engine at normal operating temperatures. For example, cold-start exhaust gas temperatures can be between approximately 60-250 degrees Celsius. Conventional SCR catalysts often fail to effectively reduce NOₓ from such cold-start exhaust gas streams. Therefore, it may be desirable to provide an aftertreatment system with an SCR catalyst that can effectively reduce NOₓ with an ammonia dosing system from cold-start exhaust gas and another SCR catalyst that can effectively reduce NOₓ from exhaust gas at normal operating temperatures.

### SUMMARY

This section provides a general summary of the disclosure, and is not a comprehensive disclosure of its full scope or all of its features.

The present disclosure provides an aftertreatment system for treating exhaust gas discharged from a combustion engine, the aftertreatment system comprising a low temperature selective-catalytic-reduction catalyst, wherein the low-temperature selective-catalytic-reduction catalyst is a mixture of catalytic metals provided on a beta-zeolite support material, the mixture of catalytic metals being at least one mixture selected from Cu and Ce, Mn and Ce, Mn and Fe, Cu and W, and Ce and W, and at least one alkali metal.

The present disclosure also provides an aftertreatment system for treating exhaust gas discharged from a combustion engine, the aftertreatment system comprising a low temperature selective-catalytic-reduction catalyst, wherein the low-temperature selective-catalytic-reduction catalyst includes one alkali metal and/or one lanthanide group metal, as well as a first catalytic metal and a second catalytic metal that are each dispersed on a beta-zeolite support material, wherein the first and second catalytic metals are each selected from the group consisting of Cu, Ce, Mn, Fe, and W.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of an engine and aftertreatment system according to the principles of the present disclosure;

FIG. 2 is a schematic representation of another aftertreatment system according to the principles of the present disclosure;

FIG. 3 is a schematic representation of yet another aftertreatment system according to the principles of the present disclosure;

FIG. 4 is a schematic representation of yet another aftertreatment system according to the principles of the present disclosure;

FIG. 5 is a schematic representation of yet another aftertreatment system according to the principles of the present disclosure;

FIG. 6 is a schematic representation of yet another aftertreatment system according to the principles of the present disclosure;

FIG. 7 is a graph illustrating the efficacy of the catalysts at removing NOx from the exhaust stream at various exhaust temperatures;

FIG. 8 is a graph illustrating the efficacy of the catalysts at removing NOx from the exhaust stream at various exhaust temperatures; and

FIG. 9 is a graph illustrating the efficacy of the catalysts at removing NOx from the exhaust stream at various exhaust temperatures;

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

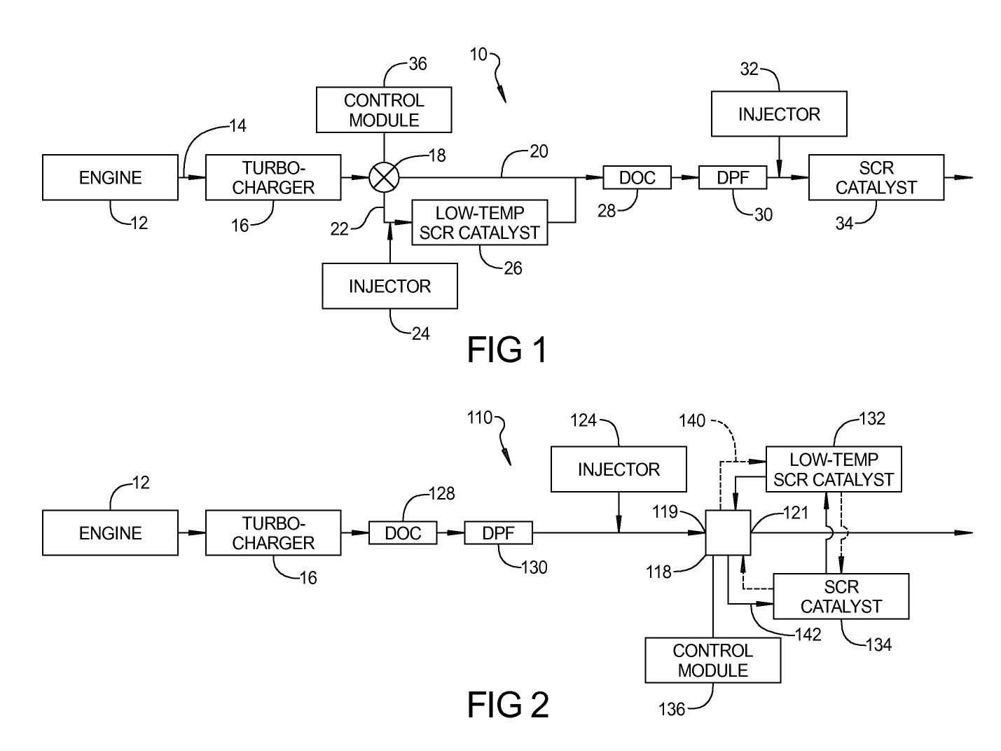

FIG. 1 depicts an exhaust gas aftertreatment system 10 for treating the exhaust output from an exemplary engine 12 to an exhaust passageway 14. A turbocharger 16 includes a driven member (not shown) positioned in an exhaust stream. During engine operation, the exhaust stream causes the driven member to rotate and provide compressed air to an intake passage (not shown) of the engine 12. It will be appreciated that the exhaust gas aftertreatment system 10 can also be used to treat exhaust output from a naturally aspirated engine or any other engine that does not include a turbocharger.

The exhaust aftertreatment system 10 may include a control valve 18, a bypass flow path 20, a low-temperature-treatment flow path 22, a first injector or injection port 24 (e.g., a diesel exhaust fluid (DEF) dosing system or urea or ammonia injector, nozzle or other orifice through which reagent can be injected into the exhaust stream), a first selective-catalytic-reduction (SCR) catalyst 26, a diesel oxidation catalyst (DOC) 28, a diesel particulate filter (DPF) 30, a second injector or injection port 32 (e.g., a DEF dosing system or urea or ammonia injector, nozzle or other orifice through which reagent can be injected into the exhaust stream), and a second SCR catalyst 34. The low-temperature-treatment flow path 22 may include the first injector 24 and the first SCR catalyst 26. The first injector 24 may inject a gaseous ammonia, for example, or any other reagent into the exhaust stream upstream of the first SCR catalyst 26. The first injector 24 may be disposed directly or indirectly adjacent and/or proximate to the first SCR catalyst 26.

The first SCR catalyst 26 may be a low-temperature SCR catalyst configured to effectively reduce NOₓ from low-temperature exhaust gas (e.g., exhaust gas at 60-150 degrees Celsius or 60-250 degrees Celsius) that may be discharged from the engine 12 for a period of time following a cold start of the engine 12. For example, the first SCR catalyst 26 may include a metal loaded onto the beta-zeolite by a cation exchange method, as will be described in more detail below. It will be appreciated that any suitable low-temperature SCR catalyst capable of effectively treating low-temperature exhaust gas could be employed.

Exhaust flowing through the bypass flow path 20 bypasses the first injector 24 and the first SCR catalyst 26. The control valve 18 may receive exhaust gas from the engine 12 and turbocharger 16 and may be movable between first and second positions. In the first position, the control valve 18 allows exhaust gas to flow through the low-temperature-treatment flow path 22 and restricts or prevents exhaust gas from flowing through the bypass flow path 20. In the second position, the control valve 18 allows exhaust gas to flow through the bypass flow path 20 and prevents exhaust gas from flowing through the low-temperature-treatment flow path 22. In some configurations, the control valve 18 may be movable to one or more intermediate positions between the first and second positions to allow a portion of the exhaust gas to flow through the bypass flow path 20 and another portion of the exhaust gas to flow through the low-temperature treatment flow path 22.

A control module 36 may control movement of the control valve 18 based on a temperature of the exhaust gas discharged from the engine 12 (measured by a temperature sensor in the exhaust stream), a temperature of engine coolant (measured by an engine coolant temperature sensor) and/or a runtime of the engine 12, for example. The control module 36 may cause the control valve 18 to move into the first position when the exhaust temperature or coolant temperature is below a predetermined value (between about 150 or 250 degrees Celsius, for example). The control module 36 may cause the control valve 18 to move into the second position once the exhaust temperature or coolant temperature rises above the predetermined value.

The control module 36 may include or be part of an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip. The control module 36 may be a part of or include a control unit controlling one or more other vehicle systems. Alternatively, the control module 36 may be a control unit dedicated to the exhaust aftertreatment system 10. The control module 36 may be in communication with and control operation of the control valve 18, the injectors 24, 32 and/or other aftertreatment components.

The DOC 28, the DPF 30, the second injector 32 and the second SCR catalyst 34 may be disposed downstream of the bypass flow path 20 and the low-temperature-treatment flow path 22. The DPF 30 may be disposed downstream of the DOC 28. The DPF 30 may be disposed directly or indirectly adjacent and/or proximate to the DOC 28. The second injector 32 may be disposed downstream of the DPF 30 and upstream of the second SCR catalyst 34. The second injector 32 may be disposed directly or indirectly adjacent and/or proximate to the second SCR catalyst 34. The second SCR catalyst 34 may be a normal-to-high-temperature SCR catalyst configured to effectively reduce NOₓ from normal-to-high-temperature exhaust gas (e.g., exhaust approximately equal to or greater than about 150 degrees Celsius, or approximately equal to or greater than about 250 degrees Celsius) that may be discharged from the engine 12 under normal and/or high-load operating conditions.

With reference to FIG. 2, another aftertreatment system 110 is provided that may treat the exhaust gas discharged from the engine 12. The aftertreatment system 110 may include a DOC 128, a DPF 130, an injector or injection port 124, a control valve 118, a low-temperature SCR catalyst 132, a normal-to-high-temperature SCR catalyst 134, and a control module 136. The structure and function of the DOC 128, DPF 130, injector 124, SCR catalysts 132, 134, and control module 136 may be similar or identical to that of the DOC 28, DPF 30, injector 24,32, SCR catalysts 26, 34, and control module 36, respectively, apart from any exceptions described below and/or shown in the figures. Therefore, similar features will not be described again in detail.

The DOC 128 may receive exhaust gas from the engine 12 and turbocharger 16. The DPF 130 may be disposed downstream of the DOC 128. The injector 124 may inject ammonia (or another reagent) into the exhaust stream downstream of the DPF 130 and upstream of the control valve 118. The control valve 118 may be fluidly coupled to the low-temperature SCR catalyst 132 and the normal-to-high-temperature SCR catalyst 134. The low-temperature SCR catalyst 132 and the normal-to-high-temperature SCR catalyst 134 may be fluidly coupled to each other.

The control module 136 may cause the control valve 118 to move between first and second positions. In the first position, fluid received through an inlet 119 of the control valve 118 is routed along a first flow path 140 (indicated in dashed lines in FIG. 2) in which the fluid flows from the control valve 118 to the low-temperature SCR catalyst 132, then to the normal-to-high-temperature SCR catalyst 134, then back to the control valve 118. The fluid then exits the control valve 118 through an outlet 121 before being discharged into the ambient environment. When the control valve 118 is in the second position, fluid received through the inlet 119 of the control valve 118 is routed along a second flow path 142 (indicated in solid lines in FIG. 2) in which the fluid flows from the control valve 118 to the normal-to-high-temperature SCR catalyst 134, then to the low-temperature SCR catalyst 132, then back to the control valve 118. The fluid then exits the control valve 118 through the outlet 121 before being discharged into the ambient environment.

As described above, the control module 136 may control movement of the control valve 118 based on a temperature of the exhaust gas discharged from the engine 12, a temperature of engine coolant and/or a runtime of the engine 12, for example. The control module 136 may cause the control valve 118 to move into the first position when the exhaust temperature or coolant temperature is below a predetermined value (between about 150 or 250 degrees Celsius, for example). The control module 136 may cause the control valve 118 to move into the second position once the exhaust temperature or coolant temperature rises above the predetermined value.

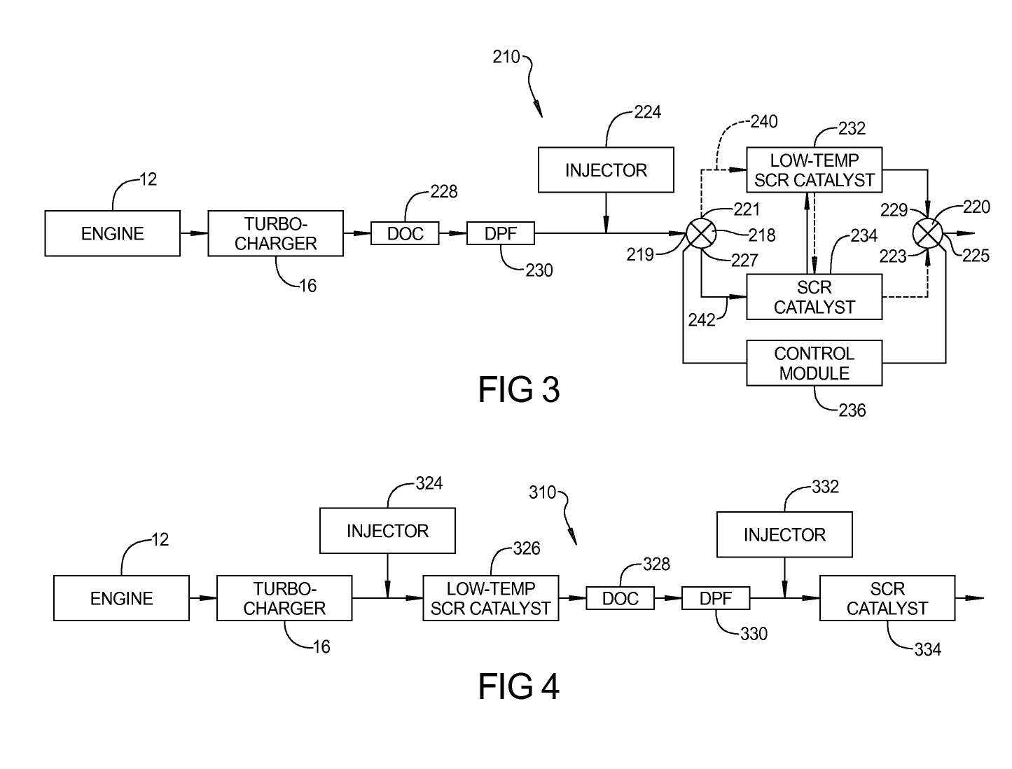

With reference to FIG. 3, another aftertreatment system 210 is provided that may treat the exhaust gas discharged from the engine 12. The aftertreatment system 210 may include a DOC 228, a DPF 230, an injector or injection port 224, a first control valve 218, a second control valve 220, a low-temperature SCR catalyst 232, a normal-to-high-temperature SCR catalyst 234, and a control module 236. The structure and function of the DOC 228, DPF 230, injector 224, SCR catalysts 232, 234, and control module 236 may be similar or identical to that of the DOC 28, DPF 30, injector 24,32, SCR catalysts 26, 34, and control module 36, respectively, apart from any exceptions described below and/or shown in the figures. Therefore, similar features will not be described again in detail.

The DOC 228 may receive exhaust gas from the engine 12 and turbocharger 16. The DPF 230 may be disposed downstream of the DOC 228. The injector 224 may inject ammonia (or other reagent) into the exhaust stream downstream of the DPF 230 and upstream of the first control valve 218. The first control valve 218 may be fluidly coupled to the low-temperature SCR catalyst 232 and the normal-to-high-temperature SCR catalyst 234. The low-temperature SCR catalyst 232 and the normal-to-high-temperature SCR catalyst 234 may be fluidly coupled to each other. The second control valve 220 may be fluidly coupled to the low-temperature SCR catalyst 232 and the normal-to-high-temperature SCR catalyst 234.

The control module 236 may cause the first and second control valves 218, 220 to move substantially simultaneously between first and second positions. When the control valves 218, 220 are in the first position, fluid received through an inlet 219 of the first control valve 218 is routed out of the first control valve 218 through a first outlet 221 along a first flow path 240 (indicated in dashed lines in FIG. 3) to the low-temperature SCR catalyst 232. From the low-temperature SCR catalyst 232, the fluid flows to the normal-to-high-temperature SCR catalyst 234, and then into a first inlet 223 of the second control valve 220. The fluid then exits the second control valve 220 through an outlet 225 before being discharged into the ambient environment. When the control valves 218, 220 are in the second position, fluid received through the inlet 219 of the first control valve 218 is routed out of the first control valve 218 through a second outlet 227 along a second flow path 242 (indicated in solid lines in FIG. 3) to the normal-to-high-temperature SCR catalyst 234. From the normal-to-high-temperature SCR catalyst 234, the fluid flows to the low-temperature SCR catalyst 232, and then into a second inlet 229 of the second control valve 220. The fluid then exits the second control valve 220 through the outlet 225 before being discharged into the ambient environment.

As described above, the control module 236 may control movement of the valves 218, 220 based on a temperature of the exhaust gas discharged from the engine 12, a temperature of engine coolant and/or a runtime of the engine 12, for example. The control module 236 may cause the valves 218, 220 to move into the first position when the exhaust temperature or coolant temperature is below a predetermined value (between about 150 or 250 degrees Celsius, for example). The control module 236 may cause the valves 218, 220 to move into the second position once the exhaust temperature or coolant temperature rises above the predetermined value.

With reference to FIG. 4, another aftertreatment system 310 is provided that may treat the exhaust gas discharged from the engine 12. The aftertreatment system 310 may include a first injector or injection port 324, a low-temperature SCR catalyst 326, a DOC 328, a DPF 330, a second injector or injection port 332 and a normal-to-high-temperature SCR catalyst 334. The structure and function of the injectors 324, 332, the SCR catalysts 326, 334, the DOC 328 and the DPF 330 may be similar or identical to that of the injectors 24, 32, the SCR catalysts 26, 34, the DOC 28 and the DPF 30, respectively, apart from any exceptions described below and/or shown in the figures. Therefore, similar features will not be described again in detail.

The first injector 324 may inject ammonia (or any other reagent) into the exhaust stream downstream of the engine 12 and turbocharger 16. The low-temperature SCR catalyst 326 may be disposed downstream of the first injector 324 and may be disposed directly or indirectly adjacent and/or proximate to the first injector 324. The DOC 328 may be disposed downstream of the low-temperature SCR catalyst 326. The DPF 330 may be disposed downstream of the DOC 328 and may be directly or indirectly adjacent and/or proximate to the DOC 328. The second injector 332 may be disposed downstream of the DPF 330 and upstream of the normal-to-high-temperature SCR catalyst 334. The second injector 332 may be directly or indirectly adjacent and/or proximate to the normal-to-high-temperature SCR catalyst 334.

With reference to FIG. 5, another aftertreatment system 410 is provided that may treat the exhaust gas discharged from the engine 12. The aftertreatment system 410 may include a first control valve 418, a bypass flow path 420, a low-temperature-treatment flow path 422, and a second control valve 424. A control module 426 may be in communication with and control operation of the first and second control valves 418, 424. The structure and function of the control module 426 may be similar or identical to that of the control module 36 described above, apart from any exceptions described herein and/or shown in the figures.

The bypass flow path 420 may be in fluid communication with the first and second control valves 418, 424 and may include a DOC 428, a DPF 430, a first injector or injection port 432, and a normal-to-high-temperature SCR catalyst 434. The DOC 428 and DPF 430 may be disposed between the first and second control valves 418, 424 and may be directly or indirectly adjacent and/or proximate to each other. The first injector 432 may inject ammonia (or another reagent) downstream of the DPF 430 and upstream of the second control valve 424. The normal-to-high-temperature SCR catalyst 434 may be disposed downstream of the second control valve 424. The structure and function of the DOC 428, the DPF 430, the first injector 432, and the normal-to-high-temperature SCR catalyst 434 may be similar or identical to that of the DOC 28, the DPF 30, the second injector 32, and the second SCR catalyst 34, respectively, apart from any exceptions described herein and/or shown in the figures.

The low-temperature-treatment flow path 422 may be in fluid communication with the first and second control valves 418, 424 and may include a second injector or injection port 436 and a low-temperature SCR catalyst 438. The structure and function of the second injector 436 and the low-temperature SCR catalyst 438 may be similar or identical to that of the injector 24 and low-temperature SCR catalyst 26, respectively, apart from any exceptions described herein and/or shown in the figures. Therefore, similar features will not be described again in detail. Briefly, the second injector 436 may inject gaseous ammonia, for example, and/or another reagent into the exhaust stream in the low-temperature-treatment flow path 422 between the first and second control valves 418, 424. The low-temperature SCR catalyst 438 may be disposed downstream of the second control valve 424.

The control module 426 may move the first and second control valves 418, 424 substantially simultaneously between first and second positions. When the control valves 418, 424 are in the first position, fluid received through an inlet 419 of the first control valve 418 is routed out of the first control valve 418 through a first outlet 421 and into the low-temperature-treatment flow path 422. As described above, the second injector 436 may inject reagent into the low-temperature-treatment flow path 422 between the first and second control valves 424. Then, the exhaust stream may flow into a first inlet 423 of the second control valve 424 and exit the second control valve 424 through a first outlet 425. From the first outlet 425, the exhaust may flow through the low-temperature SCR catalyst 438 before being discharged to the ambient environment. The low-temperature-treatment flow path 422 may bypass the DOC 428, the DPF 430, the first injector 432 and the normal-to-high-temperature SCR catalyst 434.

When the control valves 418, 424 are in the second position, fluid received through the inlet 419 of the first control valve 418 is routed out of the first control valve 418 through a second outlet 427 and into the bypass flow path 420. From the second outlet 427, the fluid may flow through the DOC 428 and through the DPF 430 before reagent is injected into the exhaust stream by the first injector 432. Thereafter, the exhaust may flow into the second control valve 424 through a second inlet 429 and out of the second control valve 424 through a second outlet 431. From the second outlet 431, the exhaust may flow through the normal-to-high-temperature SCR catalyst 434 before being discharged into the ambient environment.

As described above, the control module 426 may control movement of the control valves 418, 424 based on a temperature of the exhaust gas discharged from the engine 12, a temperature of engine coolant and/or a runtime of the engine 12, for example. The control module 426 may cause the control valves 418, 424 to move into the first position when the exhaust temperature or coolant temperature is below a predetermined value (between about 150 or 250 degrees Celsius, for example). The control module 426 may cause the control valves 418, 424 to move into the second position once the exhaust temperature or coolant temperature rises above the predetermined value.

In some configurations, the control module 426 may, under certain conditions, cause the first control valve 418 to be in the first position while the second control valve 424 is in the second position. While the control valves 418, 424 are in such positions, the exhaust gas may flow from the first control valve 418 through an upstream portion of the low-temperature-treatment flow path 422 (bypassing the DOC 428, the DPF 430 and first injector 432) and out of the second outlet 431 of the second control valve 424 to the normal-to-high-temperature SCR catalyst 434 before being discharged to the ambient environment.

In some configurations, the control module 426 may, under certain conditions, cause the first control valve 418 to be in the second position while the second control valve 424 is in the first position. While the control valves 418, 424 are in such positions, the exhaust gas may flow from the first control valve 418 through the DOC 428 and the DPF 430. From the DPF 430, the exhaust stream may flow into the second control valve 424 and exit the second control valve 424 through the first outlet 425. From the first outlet 425, the exhaust may flow through the low-temperature SCR catalyst 438 before being discharged to the ambient environment.

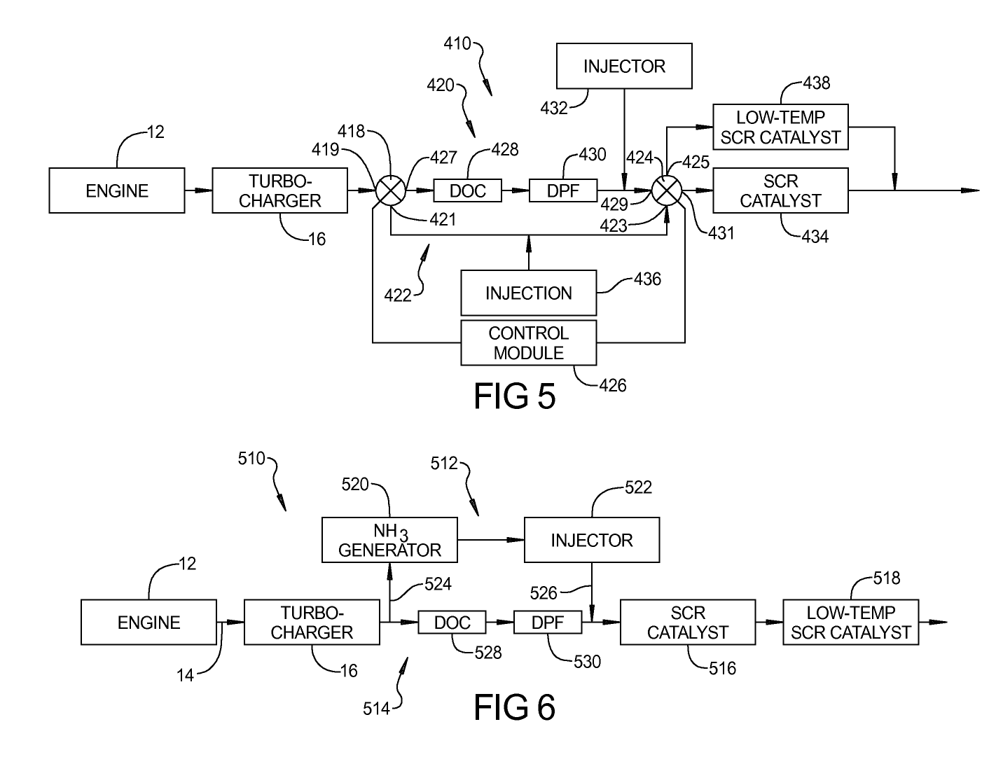

With reference to FIG. 6, another aftertreatment system 510 is provided that may treat the exhaust gas discharged from the engine 12. The aftertreatment system 510 may include a first exhaust gas flow path 512, a second exhaust gas flow path 514, a normal-to-high-temperature SCR catalyst 516 and a low-temperature SCR catalyst 518. While FIG. 6 depicts the normal-to-high-temperature SCR catalyst 516 being upstream of the low-temperature SCR catalyst 518, in some embodiments, low-temperature SCR catalyst 518 may be disposed upstream of the normal-to-high-temperature SCR catalyst 516. The structure and function of the SCR catalysts 516, 518 may be similar or identical to that of the SCR catalysts 34, 26, respectively, apart from any exceptions described below and/or shown in the figures. Therefore, similar features will not be described again in detail.

The first exhaust gas flow path 512 may include an ammonia gas generator 520 and an injector or injection port 522 (e.g., an injector, nozzle and/or other orifice through which reagent can be injected into the exhaust stream). FIG. 6 shows an inlet 524 of the first exhaust gas flow path 512 disposed downstream of the turbocharger 16. In some embodiments, however, the inlet 526 may be upstream of the turbocharger 16 so that fluid flowing through the first exhaust gas flow path 512 bypasses the turbocharger 16. The ammonia gas generator 520 may receive exhaust gas and convert urea (or another compound containing ammonia) to gaseous ammonia (or a gas containing ammonia). An outlet 526 of the first exhaust gas flow path 512 may be disposed upstream of the SCR catalysts 516, 518 such that the injector 522 may feed the exhaust and gaseous ammonia to the SCR catalysts 516, 518.

The second exhaust gas flow path 514 may include a DOC 528 and a DPF 530. The DOC 528 and DPF 530 may be disposed between the inlet 524 and outlet 526 of the first exhaust gas flow path 512. The DOC 528 may be upstream or downstream of the DPF 530. The structure and function of the DOC 528 and DPF 530 may be similar or identical to that of the DOC 28 and DPF 30 described above.

It will be appreciated that any of the aftertreatment systems 10, 110, 210, 310, 410 described above may include an exhaust flow path similar or identical to the first exhaust gas flow path 512 (e.g., including the ammonia gas generator 520 and/or injector or injection port 522) that may bypass the DOC, DPF and/or one or more other components of the aftertreatment system 10, 110, 210, 310, 410. Further, it will be appreciated that any DPF described above may include one of the low-temperature SCR catalysts described below without departing from the scope of the present disclosure.

According to the present disclosure, the catalysts that are used include a pair of metals selected from the group of copper (Cu), cerium (Ce), manganese (Mn), iron (Fe), and tungsten (W). The catalysts may be deposited on a zeolite support material. The catalysts are preferably deposited on a beta-zeolite material. It should be understood, however, that the use of SiO₂, TiO₂, alumina, or a zeolite material is also contemplated.

Most preferably, the catalyst formulations include a mixture of Cu and Ce on a beta-zeolite support material, a mixture of Mn and Ce on a beta-zeolite support material, a mixture of Mn and Fe on a beta-zeolite support material, a mixture of Cu and W on a beta-zeolite, and a mixture of Ce and W on a beta-zeolite material. A loading of each catalyst metal may lie in the range of 0.5 wt % to 20 wt %, with the balance being the selected support material. Preferably, a ratio of an amount of a first metal relative to an amount of a second metal of the mixture is in the range of 1.5 to 40, more preferably 3 to 25, and most preferably 5 to 20. The preparation methods for the catalysts can be selected from cationic exchange, deposition-precipitation, wet-impregnation, or any combinations thereof. Among all the techniques used, catalysts prepared by using cation-exchange method, and incipient wetness technique showed an impressive performance for the SCR of NOₓ with ammonia in the temperature range 100° C.-350° C.

In addition, the catalysts may also include a small quantity of an alkali metal such as lithium (Li), sodium (Na), potassium (K), rubidium (Rb), caesium (Cs), and francium (Fr), most preferably Na. Alternatively or in addition to the alkali metal, the catalysts may also include a small quantity of lanthanide group metal selected from the group consisting lanthanum (La), praseodymium (Pr), neodymium (Nd), promethium (Pm), samarium (Sm), europium (Eu), Gadolinium (Gd), terbium (Tb), dysprosium (Dy), holmium (Ho), erbium (Er), thulium (Tm), ytterbium (Yb), and luterium (Lu). These materials assist in ion-exchange of the catalyst metals onto the beta-zeolite support material, and may be present in the final catalyst formulations in amounts that range between 0.05 wt % to 1 wt %.

It should also be understood that the catalyst formulations can include a third catalyst metal, if desired, selected from the above-noted group of catalyst metals selected from the group consisting of Cu, Ce, Mn, Fe, and W. For example, the mixture of Mn and Ce on the beta-zeolite support material could also include a third catalyst metal such as Cu, Fe, or W. The mixture of Mn and Fe on the beta-zeolite support material could also include a third catalyst metal such as Cu, Ce, or W. The mixture of Cu and W on the beta-zeolite could also include a third catalyst metal such as Ce, Mn, and Fe. Lastly, the mixture of Ce and W on the beta-zeolite material could also include a third catalyst metal such as Cu, Fe, or Mn. The deposition of the third catalyst metal onto the beta-zeolite support can be accomplished in the same manner as the first and second catalyst metals. That is, cationic exchange, deposition-precipitation, wet-impregnation, or any combinations thereof may be used to deposit the third catalyst metal. It should be understood, however, that the amount of third catalyst metal should be less than the amounts of the first and second catalyst metals. In particular, the loading of the third catalyst metal is preferably in the range of 0.05 wt % to 1.0 wt %.

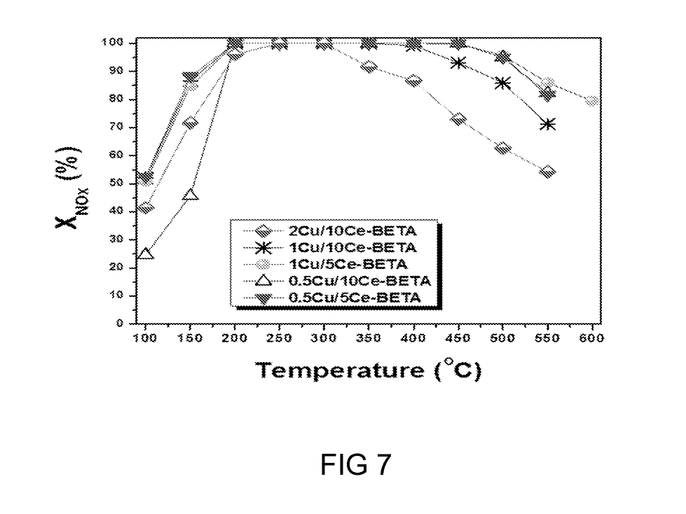

FIG. 7 illustrates exemplary low temperature catalyst formulations, and the effect these catalyst formulations have on NOx reduction at temperatures that range between 100 C and 600 C. Specifically, a mixture of Cu and Ce was deposited on a beta-zeolite support. In these samples, the ratio of Ce to Cu was in the range of 5 to 20. The test conditions included a gas stream including 900 parts per million (ppm) nitric oxide (NO), 100 ppm nitrogen dioxide (NO₂), 1000 ppm NH₃, 10 volume % O₂, with a balance of helium (He). The gas hourly space velocity (GHSV) was 80000 h⁻¹. As can be seen in FIG. 7, these catalyst formulations achieved light-off and were effective at reducing NOx in the exhaust stream at temperatures between 100C and 200 C. Further, these catalyst formulations are stable at high temperatures between 450 C to 600 C. Thus, these catalyst formulations are advantageous during low temperature and high temperature conditions of the exhaust.

The Cu/Ce-based beta-zeolite catalyst formulations discussed above were synthesized by using a cation-exchange technique followed by deposition precipitation method in order to optimize the amounts of Cu and Ce. In order to prepare the ion-exchanged Ce beta-zeolite catalysts, a powder with silica to alumina ratio of 25 (VALFOR CP 811 BL-25 a product of the PQ corporation) was used. The first step in the preparation was an aqueous ion exchange of the H-beta-zeolite with an alkali or lanthanide group metal (e.g., sodium (Na)) to assure a controlled ion exchange with metal (i.e., Cu) thereafter. The powder was stirred for 60 min in a NaNO₃ solution. During this procedure the pH was kept constant by gradually adding NH₃. This step was repeated twice and the details can be found in Table 1.

TABLE 1
Description of the ion-exchange with sodium for 10
grams of H-beta-zeolite (SiO₂/Al₂O₃) = 25.

| Step | Water (mL) | NaNO₃ (g) | Time (h) | pH |
|---|---|---|---|---|
| 1 | 500 | 4.60 | 1 | 7-8 |
| 2 | 500 | 4.60 | 1 | 7-8 |

After the exchanges with Na the beta-zeolite was dried at 120° C. before the cation exchanges (CE) were done with Ce metal content using Ce(CH₃COO)₃.xH₂O solution. All the details for these steps can be found in Table 2. In the last step of the preparation the powder was washed and dried in an oven at 120° C. for 12 h. The Ce-beta cation-exchanged (CE) zeolite was used for the synthesis of Cu/Ce-beta formulations using deposition precipitation (DP) method.

To add Cu to the Ce-beta powder by deposition precipitation, formulations were prepared starting with a suspension of dried Ce-beta powder in a solution of Cu(NO₃)₂2.5H₂O (Sigma-Aldrich). After stirring at room temperature for 1 h, the Cu(NO₃)₂2.5H₂O solution was slowly precipitated by adding an aqueous solution of NH₃. During this procedure, the pH was kept constant (pH 7-8) by gradually adding NH₃ at ambient temperature. The resultant catalyst precipitation was washed with deionized water until pH was 7 and then dried in an oven at 120° C. for 12 h. The final Cu/Ce-beta powder catalysts were calcined in a tubular oven at 550° C. for 5 hours in an open-air atmosphere.

TABLE 2
Description of the cation-exchange and deposition-
precipitation synthesis techniques.

| | | | | pH | |
|---|---|---|---|---|---|
| | | | Water | (CE/ | |
| S. No. | Catalyst | Method^{a} | (mL) | DP) | Calcination |
| 1 | 10 wt. % Ce-beta | cation-exchange | 200 | 7-8 | 550° C./5 hrs |
| | | (CE) | | | |
| 2 | 5 wt. % Ce-beta | cation-exchange | 200 | 7-8 | 550° C./5 hrs |
| | | (CE) | | | |
| 3 | 2 wt. % Cu/10 wt. % Ce- | CE followed by DP | 200 | 7-8 | 550° C./5 hrs |
| | beta | | | | |
| 4 | 3 wt. % Cu/10 wt. % Ce- | CE followed by DP | 200 | 7-8 | 550° C./5 hrs |
| | beta | | | | |
| 5 | 4 wt. % Cu/10 wt. % Ce- | CE followed by DP | 200 | 7-8 | 550° C./5 hrs |
| | beta | | | | |
| 6 | 5 wt. % Cu/10 wt. % Ce- | CE followed by DP | 200 | 7-8 | 550° C./5 hrs |
| | beta | | | | |
| 7 | 3 wt. % Cu/5 wt. % Ce- | CE followed by DP | 200 | 7-8 | 550° C./5 hrs |
| | beta | | | | |
| 8 | 2 wt. % Cu/10 wt. % Ce- | CE followed by DP | 100 | 7-8 | 550° C./5 hrs |
| | beta | | | | |
| 7 | 2 wt. % Cu/10 wt. % Ce- | CE followed by DP | 100 | 7-8 | 550° C./5 hrs |
| | beta | | | | |

^{a}Catalyst synthesis method: CE = cation-exchange; CE & DP or DP & CE = cation-exchange followed by deposition precipitation

In order to prepare ion-exchanged zeolite catalysts including Mn, Fe, Ce, Mn and Ce, or Mn and Fe, a powder with silica to alumina ratio of 25 (VALFOR CP 811 BL-25 a product of the PQ corporation) was used. Similar to the synthesis of the Cu/Ce beta-zeolite catalysts, the first step in the preparation was an aqueous ion exchange of the H-beta zeolite with an alkali or lanthanide group metal (e.g., sodium (Na)) to assure a controlled ion exchange with metal (e.g., Mn, Fe, or Ce) thereafter. The powder was stirred for 60 min in a NaNO₃ solution. During this procedure the pH was kept constant by gradually adding NH₃. This step was repeated twice and the details can be found in Table 3.

TABLE 3
Description of the ion-exchange with sodium for 10
grams of H-beta zeolite (SiO₂/Al₂O₃) = 25.

| Step | Water (mL) | NaNO₃ (g) | Time (h) | pH |
|---|---|---|---|---|
| 1 | 500 | 4.60 | 1 | 7-8 |
| 2 | 500 | 4.60 | 1 | 7-8 |

After the exchanges with Na, the metal-exchanged zeolites were dried at 120° C. before the cation exchanges were done with various metal contents using Mn, Ce, and Fe (e.g., Mn(CH₃COO)₂.4H₂O, Ce(CH₃COO)₃.xH₂), or FeCl₃.6H₂O) solutions, respectively. The details for these steps can be found in Table 4. In the last step of the preparation, the powders were washed and dried in an oven at 120° C. for 12 h. The H-beta zeolite powder was used as received for the incipient wetness technique. Prior to the reaction studies, the powder catalysts were calcined in a tubular oven at 500° C./550° C. for 5 hours in an open-air.

TABLE 4
Description of the cation-exchange and wet-impregnation.

| | | Water | | | |
|---|---|---|---|---|---|
| Catalyst | Method^{a} | (mL) | Metal (wt. %) | Time (h) | pH |
| 5Fe-β | CE | 200 | 5 | 18 | 7-8 |
| 5Mn-β | CE | 200 | 5 | 18 | 7-8 |
| 10Mn-β | CE | 200 | 10 | 18 | 7-8 |
| 10Ce-β | CE | 200 | 10 | 18 | 7-8 |
| 3Mn—10Ce-β(2 | CE | 200 | 3 (Mn) 10 (Ce) | 18 | 7-8 |
| steps) | | | | | |
| 20Mn/5Fe-β(2 | CE, WI | 100 | 20 (Mn) 5 (Fe) | — | — |
| steps) | | | | | |
| 20Mn—10Ce/β | WI | 100 | 20 (Mn) 10 | — | — |
| | | | (Ce) | | |

^{a}Catalyst synthesis method: CE = cation-exchange; WI = wet-impregnation

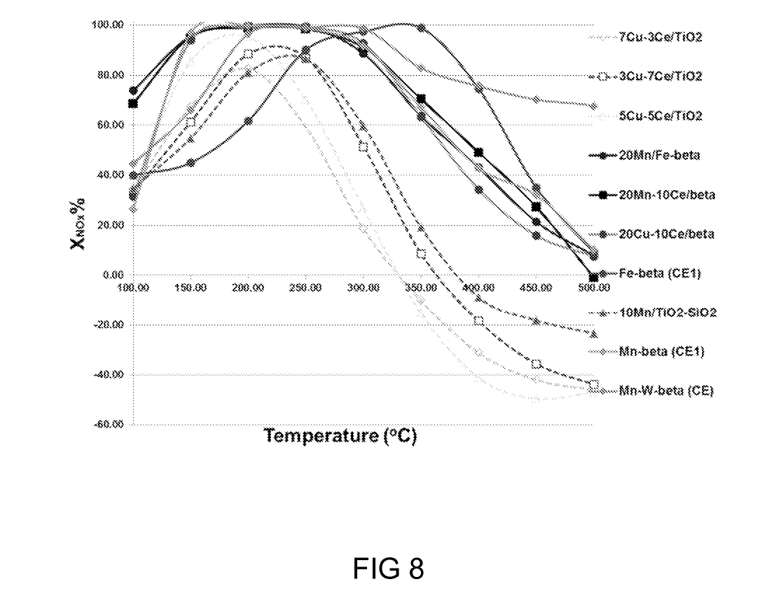

FIG. 8 illustrates exemplary low temperature catalyst formulations according to the present disclosure prepared as noted above, as well as some comparison catalyst formulations, and the effect these catalyst formulations have on NOx reduction at temperatures that range between 100 C and 500 C. The low temperature catalyst formulations according to the present disclosure include Mn/Fe on beta-zeolite, Mn/Ce on beta-zeolite, Cu/Ce on beta-zeolite, Fe on beta-zeolite, Mn on beta-zeolite, and Mn/W on beta-zeolite. In these samples, the ratio of the first catalyst metal to the second catalyst metal ranged between 1 to 20.

Comparison formulations include various loadings of Cu/Ce on TiO2, Mn on TiO2/SiO2. In these samples, the ratio of the first catalyst metal to the second catalyst metal was in the range of 0.4 to 2.3. The test conditions included a gas stream including 900 parts per million (ppm) nitric oxide (NO), 100 ppm nitrogen dioxide (NO₂), 1000 ppm NH₃, 10 volume % O₂, with a balance of helium (He). The gas hourly space velocity (GHSV) was 80000 h⁻¹.

As can be seen in FIG. 8, the catalyst formulations according to the present disclosure (i.e., those deposited on beta-zeolite) achieved fast light-off and were effective at reducing NOx in the exhaust stream at temperatures between 100 C and 350 C in comparison to the comparison compositions. Further, the catalyst formulations according to the present disclosure are stable at high temperatures between 350 C to 500 C. Thus, these catalyst formulations are advantageous during low temperature and high temperature conditions of the exhaust.

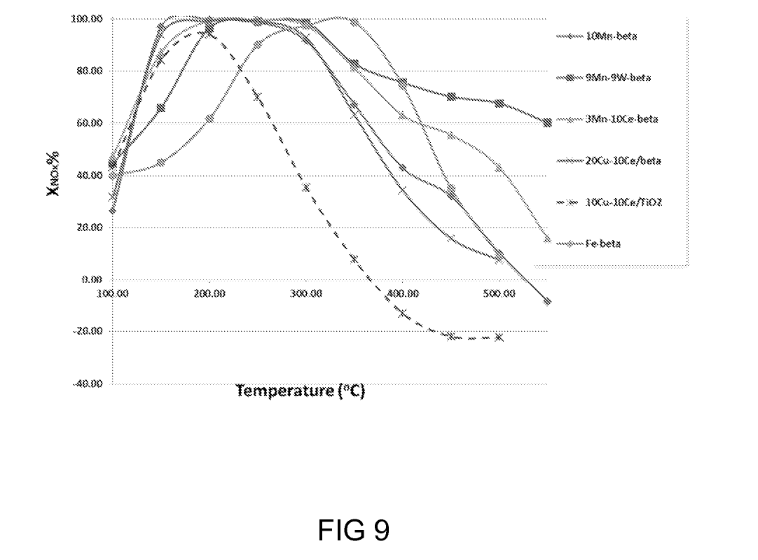

FIG. 9 illustrates exemplary low temperature catalyst formulations according to the present disclosure prepared as noted above, as well as some comparison catalyst formulations, and the effect these catalyst formulations have on NOx reduction at temperatures that range between 100 C and 500 C. The low temperature catalyst formulations according to the present disclosure include Mn on beta-zeolite, Mn/W on beta-zeolite, Mn/Ce on beta-zeolite, Cu/Ce on beta-zeolite, and Fe on beta-zeolite. In these samples, the ratio of the first catalyst metal to the second catalyst metal ranged between 1 to 10. A comparison formulation included equal parts of Cu and Ce on TiO₂.

As can be seen in FIG. 9, the catalyst formulations according to the present disclosure (i.e., those deposited on beta-zeolite) achieved fast light-off and were effective at reducing NOx in the exhaust stream at temperatures between 100 C and 350 C in comparison to the comparison composition. Further, the catalyst formulations according to the present disclosure are stable at high temperatures between 350 C to 500 C. Thus, these catalyst formulations are advantageous during low temperature and high temperature conditions of the exhaust.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An aftertreatment system for treating exhaust gas discharged from a combustion engine, the aftertreatment system comprising a low temperature selective-catalytic-reduction catalyst, wherein the low-temperature selective-catalytic-reduction catalyst is a mixture of catalytic metals provided on a beta-zeolite support material, the mixture of catalytic metals being at least one mixture selected from Cu and Ce, Mn and Ce, Mn and Fe, Cu and W, Mn and W, and Ce and W.

2. The aftertreatment system according to claim 1, wherein a loading of each metal in each mixture is in the range of 0.5 to 20 wt %, with the balance comprising the beta-zeolite support material.

3. The aftertreatment system according to claim 1, wherein a mass ratio of an amount of a first catalytic metal relative to an amount of a second catalytic metal in each mixture is in the range of 1.5 to 40.

4. The aftertreatment system according to claim 1, wherein a mass ratio of an amount of a first catalytic metal relative to an amount of a second catalytic metal in each mixture is in the range of 3 to 25.

5. The aftertreatment system according to claim 1, wherein a mass ratio of an amount of a first catalytic metal relative to an amount of a second catalytic metal in each mixture is in the range of 5 to 20.

6. The aftertreatment system according to claim 1, wherein the mixtures of catalytic metal are formed by at least one method selected from the group consisting of cation exchange, deposition precipitation, incipient wetness, and wet impregnation.

7. The aftertreatment system according to claim 1, wherein the mixture of catalytic metals in the low-temperature selective-catalytic-reduction catalyst further includes a third metal selected from Cu, Ce, Mn, Fe, and W.

8. The aftertreatment system according to claim 1, wherein the mixture of catalytic metals in the low-temperature selective-catalytic-reduction catalyst further includes an alkali metal.

9. The aftertreatment system according to claim 1, wherein the mixture of catalytic metals in the low-temperature selective-catalytic-reduction catalyst further includes a third metal selected from the lanthanide group metals.

10. An aftertreatment system for treating exhaust gas discharged from a combustion engine, the aftertreatment system comprising:
at least one of an oxidation catalyst and a particulate filter configured to receive exhaust gas;
a first selective-catalytic-reduction catalyst;
the low temperature selective-catalytic reduction catalyst of claim 1;
a valve disposed upstream of the first selective-catalytic-reduction catalyst and the at least one of the oxidation catalyst and particulate filter, the valve connected to first and second exhaust flow paths and movable between a first position allowing exhaust gas to flow through the first exhaust flow path and bypass the second exhaust flow path and a second position allowing exhaust gas to flow through the second exhaust flow path and bypass the first exhaust flow path, the low temperature selective-catalytic-reduction catalyst being disposed in the second exhaust flow path; and
a control module in communication with the valve and configured to cause the valve to move between the first and second positions based on at least one of a temperature of the exhaust gas and a temperature of the combustion engine.

11. (canceled)

12. The aftertreatment system of claim 10, wherein the first and second exhaust flow paths are disposed upstream of the first selective-catalytic-reduction catalyst.

13. The aftertreatment system of claim 10, wherein the second exhaust flow path includes a fluid injection port disposed upstream of the low temperature selective-catalytic-reduction catalyst.

14. (canceled)

15. The aftertreatment system of claim 10, wherein the at least one of the oxidation catalyst and particulate filter is disposed in the first exhaust flow path.

16. The aftertreatment system of claim 15, wherein the first selective-catalytic-reduction catalyst is disposed in the first exhaust flow path.

17. (canceled)

18. (canceled)

19. (canceled)

20. (canceled)

21. (canceled)

22. (canceled)

23. (canceled)

24. An aftertreatment system for treating exhaust gas discharged from a combustion engine, the aftertreatment system comprising a low temperature selective-catalytic-reduction catalyst, wherein the low-temperature selective-catalytic-reduction catalyst includes a first catalytic metal and a second catalytic metal dispersed on a beta-zeolite support material, wherein the first and second catalytic metals are each selected from the group consisting of Cu, Ce, Mn, Fe, and W.

25. The aftertreatment system according to claim 24, wherein the low-temperature selective-catalytic-reduction catalyst further includes a third catalytic metal selected from the group of Cu, Ce, Mn, Fe, and W.

26. The aftertreatment system according to claim 24, wherein a loading of each of the first and second catalytic metals is in the range of 0.5 to 20 wt %, with the balance comprising the beta-zeolite support material.

27. The aftertreatment system according to claim 24, wherein a mass ratio of an amount of the first catalytic metal relative to an amount of the second catalytic metal is in the range of 1.5 to 40.

28. The aftertreatment system according to claim 24, wherein a mass ratio of an amount of the first catalytic metal relative to an amount of the second catalytic metal is in the range of 3 to 25.

29. The aftertreatment system according to claim 24, wherein a mass ratio of an amount of the first catalytic metal relative to an amount of the second catalytic metal is in the range of 5 to 20.

30. The aftertreatment system according to claim 24, wherein the first and second catalytic metals are dispersed on the beta-zeolite support material by at least one method selected from the group consisting of cation exchange, deposition precipitation, incipient wetness, and wet impregnation.

31. (canceled)

32. (canceled)

33. (canceled)

34. (canceled)

35. (canceled)

36. (canceled)

37. An aftertreatment system for treating exhaust gas discharged from a combustion engine, the aftertreatment system comprising:
a first exhaust gas flow path receiving a first portion of the exhaust gas from the combustion engine, the first exhaust gas flow path including an ammonia generator and an injection port through which the ammonia is injected into the exhaust gas;
a second exhaust gas flow path receiving a second portion of the exhaust gas from the combustion engine and including at least one of a oxidation catalyst and a particulate filter;
a first selective-catalytic-reduction catalyst receiving exhaust gas from the first and second exhaust gas flow paths; and
a second selective-catalytic-reduction catalyst receiving exhaust gas from the first and second exhaust gas flow paths, the second selective-catalytic-reduction catalyst being the low-temperature selective-catalytic-reduction catalyst according to claim 24.

38. The aftertreatment system of claim 37, wherein the second selective-catalytic-reduction catalyst is disposed downstream of the first selective-catalytic-reduction catalyst.

39. The aftertreatment system of claim 37, wherein the first exhaust gas flow path includes an inlet disposed downstream of a turbocharger.

40. The aftertreatment system of claim 37, wherein the first exhaust gas flow path includes an inlet disposed upstream of a turbocharger.

41. The aftertreatment system of claim 36, wherein the injection port is disposed downstream of the ammonia generator.

42. The aftertreatment system according to claim 1, further comprising a particulate filter that includes the low-temperature selective catalytic reduction catalyst.

43. The aftertreatment system according to claim 24, further comprising a particulate filter that includes the low-temperature selective catalytic reduction catalyst.

44. The aftertreatment system according to claim 1, wherein the low-temperature selective catalytic reduction catalyst is stable at temperatures up to 500 C.

45. The aftertreatment system according to claim 24, wherein the low-temperature selective catalytic reduction catalyst is stable at temperatures up to 500 C.
